(19) United States
(12) Patent Application Publication
(10) Pub. No.: US 2011/0194915 A1
(43) Pub. Date: Aug. 11, 2011

(54) ULTRASONIC BOOK TRIMMING APPARATUS AND METHOD

(76) Inventor: Jeffrey D. Marsh, Foristell, MO (US)

(21) Appl. No.: 13/024,001

(22) Filed: Feb. 9, 2011

Related U.S. Application Data
(60) Provisional application No. 61/302,686, filed on Feb. 9, 2010.

(51) Int. Cl. B42C 99/00

(52) U.S. Cl. 412/1; 412/16

(57) ABSTRACT

Apparatus for trimming a perfect bound book is disclosed having a platen for supporting a portion of the book as it is trimmed. A clamp holds the book against the platen, and a blade is provided having a cutting edge with the blade being movable toward and away from the book platen between a retracted position and an operable position in which the cutting edge is in operative engagement with the book. An ultrasonic (or other vibratory) member carries the blade, and the ultrasonic member is rendered resonant so that the cutting edge trims the book along the side of the book. A method of trimming a book using a vibratory blade is also disclosed.

### CROSS-REFERENCE TO RELATED APPLICATIONS

This application claims priority under 35 U.S.C. §119(e) to U.S. Provisional Patent Application No. 61/302,686, filed Feb. 9, 2010, and incorporates this Provisional Application by reference in its entirety

### STATEMENT REGARDING FEDERALLY SPONSORED RESEARCH OR DEVELOPMENT

Not Applicable.

### BACKGROUND OF THE DISCLOSURE

The apparatus and method of the present disclosure relates to trimming a book, preferably but not necessarily a perfect bound book, to a predetermined finished size utilizing an ultrasonically (or other vibratory) powered trimming blade. Such an ultrasonic trimming blade is particularly useful in print on demand book publishing systems, such as disclosed in my prior U.S. Pat. Nos. 6,193,458, 6,443,682 and 7,014,182, and as described in my pending U.S. patent application Ser. No. 12/576,923, filed Oct. 9, 2009, all of which are hereby incorporated by reference in their entirety. Specifically, the trimming apparatus herein disclosed is intended as a replacement for trimming blade 63 powered by hydraulic cylinder 69, as disclosed in my U.S. Pat. No. 7,014,182, and/or as a replacement for the electrically powered shear 137, as disclosed in my U.S. patent application Ser. No. 12/576,923.

It will be appreciated that hydraulically powered shears, as disclosed in my U.S. Pat. No. 7,014,182, require a separate hydraulic system for supplying hydraulic fluid under pressure to a hydraulic cylinder, such as cylinder 69 as disclosed in my above-noted patent. The necessity of providing such a hydraulic system increases the complexity and cost of the print on demand book publishing systems described in that patent. Of course, such hydraulically powered shears were subject to occasional leaks of hydraulic fluid, which is problematic in the intended operating environment of such print on demand book publishing systems in a retail book store, library or the like. While the electrically powered shear disclosed in my pending U.S. patent application Ser. No. 12/576,923 eliminated the necessity of a hydraulic system to power the trimming shear, the electrically powered shear required the use of expensive components. Moreover, both the prior hydraulic and electric shears were required to apply high shearing loads (e.g., perhaps as much as 2,500 pounds or 1136 kg.) to the trimming blade to satisfactorily shear a thicker book (e.g., about 850 pages or about 425 sheets of paper, plus the covers). The necessity of generating such high shear loads required a shearing structure of sufficient strength to carry these loads and the drive mechanism must also be capable of applying and carrying these loads. Thus, the print on demand book publishing systems that included such a hydraulic or electric shear were expensive and heavy.

There has been a long-standing need for a book trimming apparatus that satisfactorily trimmed thicker books without the necessity of applying high shear loads, that was reliable in operation, and that was less expensive to manufacture and maintain that the above-described book trimming systems.

### SUMMARY OF THE DISCLOSURE

Apparatus for trimming a perfect bound book is disclosed. A perfect bound book has a book block having a plurality of pages and a cover. The book block has a spine along one side thereof. The cover has a center portion adhesively bound to the spine, a front cover overlying a front face of the book block, and a back cover overlying a back face of the book block. The trimming apparatus comprises a platen or a bed for supporting a portion of the book as it is trimmed. A clamp is provided for holding the book against the platen as the book is trimmed. A blade is provided having a cutting edge of a length equal to or greater than the side of the book to be trimmed with the blade being movable toward and away from the book as the latter is supported on the platen between a retracted position clear of the book and an operable position in which the cutting edge is in operative engagement with the book. An ultrasonic (or other vibratory) member carries the blade. This ultrasonic member is selectively rendered resonant so that with the cutting edge of the blade being in operable engagement with the book and upon the ultrasonic (or other vibratory) member being rendered resonant, the cutting edge trims the book along the side of the book.

Also, a method is disclosed for trimming a perfect bound book utilizing a vibratory cutting blade. The book comprises a book block having a plurality of pages and a cover. The cover has a front cover face overlying a front face of the book block, a back cover face overlying a back face of the book block, and a center portion adhesively secured to one edge of the book block, this one edge of the book block constituting a spine. The method comprises the steps of clamping the book in position to be trimmed with a margin along one side of the book exposed to be trimmed. Then, a trim blade is moved into operable engagement with the margin to be trimmed. The trim blade has a sharp cutting edge. The trim blade is rendered resonant (or otherwise vibratorily powered) while the cutting edge of the blade biased into operable engagement with the margin. Then, the blade is continued to be rendered resonant and is continued to be biased so as to be in operable engagement with the book as the cutting edge cuts through the book so as to trim the book along the margin.

### BRIEF DESCRIPTION OF THE DRAWINGS

FIG. 1 is a plan view of one embodiment of a clamp and shear assembly for a print on demand book publishing system, as it is incorporated in a trimming station similar to that disclosed in my pending U.S. patent application Ser. No. 12/576,923, illustrating a clamp positioned above an ultrasonic (or other vibratory powered) shear in accordance with the present disclosure;

FIG. 2 is a top perspective view of an ultrasonic book shear of the present disclosure disposed beneath the clamp (as shown in FIG. 1) with the clamp removed for purposes of illustration having a sonically powered blade (as shown in its retracted position); and

FIG. 3 is a top perspective diagrammatic view of an alternate embodiment of an ultrasonic book shear in which a knife/horn, booster, ultrasonic transducer and a biasing air cylinder are mounted on a frame (not shown) movable toward and away from a book along rails mounted at an angle (e.g., at a 45° angle) relative to the book to be trimmed so that upon rendering the knife/horn resonant and upon the air cylinder maintaining contact between the knife and the book, the knife slices through the book.

Corresponding reference characters indicate corresponding parts throughout the several views of the drawings.

### DESCRIPTION OF THE PREFERRED EMBODIMENTS

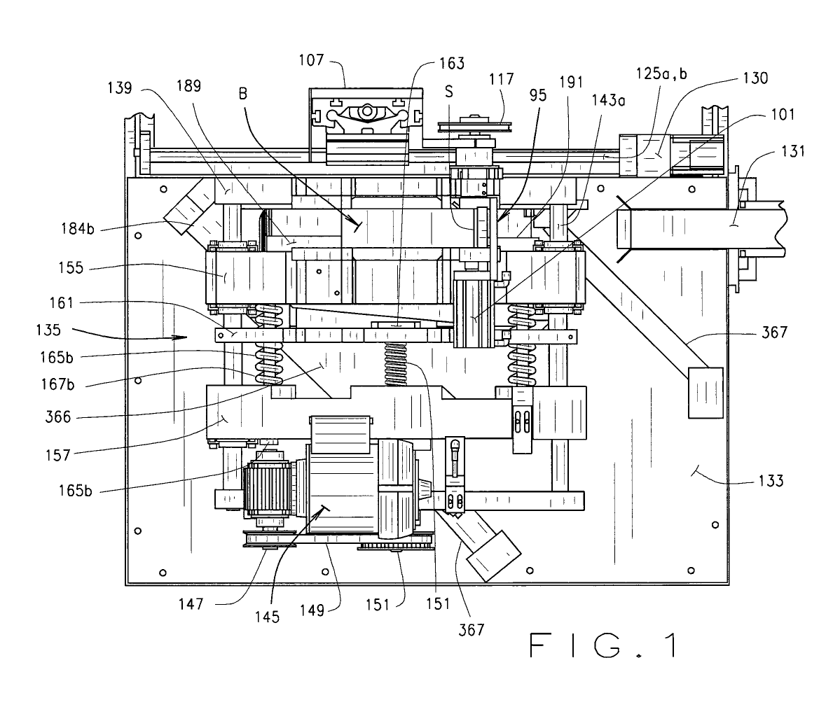

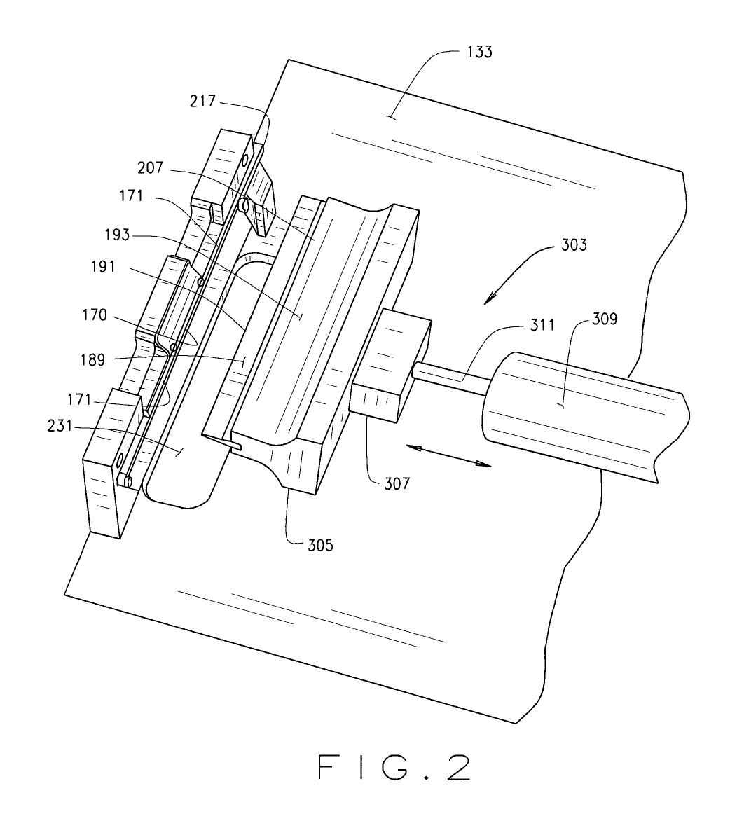

Referring to my pending U.S. patent application Ser. No. 12/576,923, which is herein incorporated by reference in its entirety, a book B is printed and bound, as described therein. The clamp and shear assembly of the present disclosure, as indicated in its entirety at 301 in FIGS. 1 and 2, is intended as a replacement for the trimming station 61 positioned below the binding station, as described in my U.S. patent application Ser. No. 12/576,923. Trimming station 301 of the present disclosure receives the bound book B which is carried and indexed by index clamp 95 in the manner disclosed in the above-noted U.S. patent application. In this disclosure, reference characters less than 301 refer to the corresponding structure in U.S. patent application Ser. No. 12/576,923. As shown in FIG. 1, a clamp 135 is provided for clamping the book to be trimmed against an anvil 139 (which constitutes a platen or support for the book as it is trimmed) in the same manner as clamp 135 of my prior application. Operation of the clamp 135 is fully described in my above-noted Application and thus will not be described herein. However, those skilled in the art will recognize that clamps of other designs may be used. In fact, when trimming books in accordance with this disclosure using an ultrasonically (or other vibratory powered) shear, it may only be necessary to clamp the book with a much lower clamping force (as compared with prior shear trimmers) to hold the book while trimming because the trimming shear forces exerted on the pages of the book are greatly reduced, thus reducing the tendency of the pages of the book to shift relative to one another as the book is trimmed.

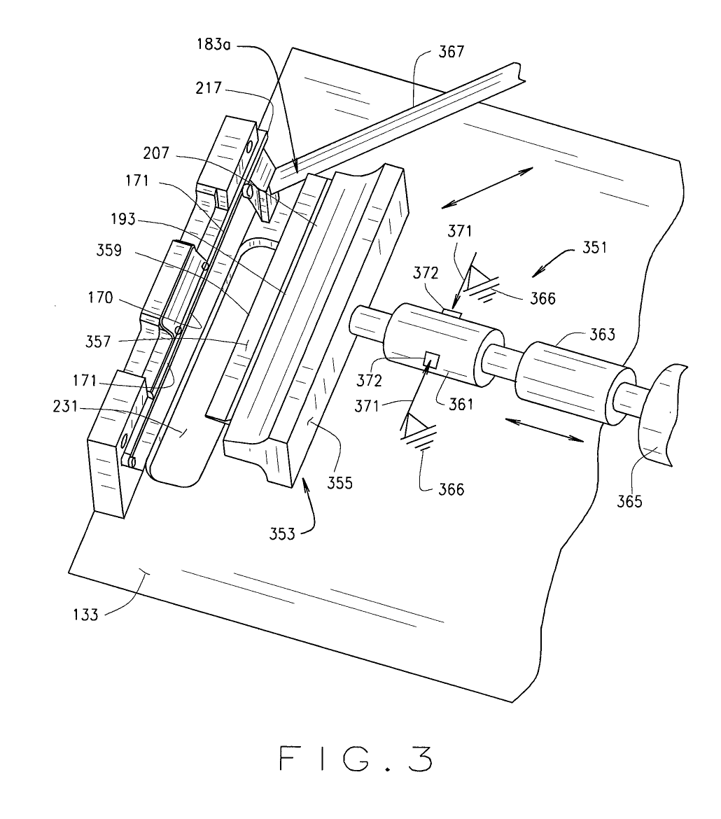

As shown in FIG. 2, an ultrasonic book trimming apparatus of the present disclosure, as indicated in its entirety at 303, is provided for trimming a perfect bound book B to a predetermined finished size. Apparatus 303 comprises an elongate trimming blade 189, preferably carbide blade, having a sharp cutting edge 191. Blade 189 is carried by an ultrasonic member or horn 305, which in turn is rendered resonant by an ultrasonic transducer 307 energized by a suitable power supply (not shown in the drawings). A suitable ultrasonic booster (not shown in FIG. 2) may be interposed between ultrasonic transducer 305 and horn 189. Such a booster is shown in regard to the embodiment shown in FIG. 3, which is described in detail hereinafter.

One such ultrasonic system which has worked well for trimming books B is one that is commercially available from Branson Ultrasonics Corporation of Danbury, Conn. Such ultrasonic tool was a 920 ma ultrasonic welder which powered the half-wave horn or tool 305 at approximately 20 KHz while the cutting edge 191 of blade 189 held in operable engagement against the book B as the book is held by clamp 135. The cutting edge 191 of the blade contacts the book margin to be trimmed along a desired trim line for the book with a contact biasing force of about 50-200 pounds applied by, for example, an air cylinder 309. As shown, air cylinder 309 has a cylinder rod 311 carrying the ultrasonic transducer 307. As noted, a booster (e.g., a 2:1 booster, not shown in FIG. 2) may be used between the ultrasonic transducer 307 and horn 305. The power supply and the control system used with this ultrasonic welder were part of the above-described commercial welder and are conventional and thus are not shown or disclosed herein, but are well-known to those skilled in the art. As noted, cutting edge 191 of blade 189 preferably contacts the full length of the outer surface of book B along the entire length of the side of the book to be trimmed.

While the trimming system disclosed herein is generally referred to as an “ultrasonic” trimming device, it will be understood that while blade 189 is preferably rendered resonant at ultrasonic frequencies, the blade may be operable at frequencies other than at ultrasonic frequencies and still operate satisfactorily to trim book B. Generally, ultrasonic frequencies are above 20,000 Hz. However, in accordance with the present disclosure, blade 189 may be rendered operable at lower or higher frequencies, depending on the design of the blade, horn 305 and transducer 307, and whether a booster used. Generally, blade 189 may be satisfactorily operable to trim a book when energized at frequencies ranging between about 5 KHz (or less) and about 40 KHz (or more). The frequency at which the blade is rendered resonant will depend on numerous factors including, but not limited to, the mass of the blade, the design of the transducer, horn and booster, and the operating characteristics of the power supply. Within the broader aspects of this disclosure, instead of using sonic or ultrasonic energy to operate blade 189, an electromagnetic or other vibratory energy source using much lower frequencies (e.g., in the several hundred Hz. Range) may be used to render the blade operable so as to trim book B. However, a sonic tool, and even more desirably, an ultrasonic energy source is preferred. As used in the claims of the present disclosure, the term “ultrasonics” is not limited to vibration frequencies above 20,000 Hz, but rather would include much lower and/or higher frequencies.

With a book B properly positioned in clamp 135 by indexing clamp 95, the clamp is closed so as to clamp the book between anvil or platen 139 and clamping member 155 with the desired trim line of this one side of the book in register with cutting edge 191 of blade 189.

While not shown in FIG. 2, it will be understood that a suitable guide or support (not shown) is provided for blade 189. Specifically, within this guide or support, blade 189 is movable by cylinder 309 between a retracted position (as shown in FIG. 2) in which a book B held by index clamp 95 is free to be positioned within clamp 135, and a trimming position (not shown) in which the cutting edge 191 of blade 189 engages book B along the desired trim line for this one side of the book. Preferably, this guide or support does not interfere with rendering the blade resonant. More details of such a guide or support are disclosed in regard to the embodiment shown in FIG. 3.

With the book B clamped in position by clamp 135, with blade 189 in its trimming position, and with the cutting edge 191 biased against the book, ultrasonic transducer 307 is energized so as to render blade 189 resonant. Cylinder 309 continues to apply a biasing force to the blade so as to maintain contact between the cutting edge and the book as the blade vibrates. It will be appreciated that as the blade is rendered resonant, it repeatedly moves toward and away from the book a short distance (e.g., about 0.001 inches or 0.025 mm.) and the sharp cutting edge 191 repeatedly impacts on the book along the length of the blade. This repeated impact with the book causes the cutting edge to shear or otherwise cut through the book along length of the side of the book being trimmed. In this manner, it has been found that even thick books having about 850 pages (425 sheets) and having front and back paper covers of heavier stock than the pages of the book block may be accurately trimmed from one side of the book in a very short time (e.g., a few seconds). Because only one or a few pages of the book are cut at a time by blade 189 on each vibration or stroke of the blade, the only force required to so trim the book is the biasing force used to maintain contact between the cutting edge and the book. This biasing force, as applied to blade 189 by air cylinder 309, is much lower than the forces required to shear the book using hydraulic or electric shears, as described in my above-noted U.S. patents and in my above noted pending U.S. patent application. It will be appreciated by those skilled in the art that some trial and error may be required to render the blade resonant as the frequency at which the blade is rendered resonant depends on the shape and mass of the blade, as well as the output of the transducer 307 and its power supply. However, the amount of experimentation required is well known to those familiar with new ultrasonic applications.

After a first side of the book is trimmed, clamp 135 is operated so as to release the book, and the indexing clamp 95 is operated so as to rotate the book to shear another side of the book, as disclosed in my pending U.S. patent application Ser. No. 12/576,923.

As shown in FIG. 2, air cylinder 309 is positioned to move blade 189 perpendicularly toward and away from the book B to be trimmed as the blade is rendered resonant. However, it will be appreciated that it may be desirable that the blade be moved at an angle with respect to the book, for example, at a 45° angle (as shown in FIG. 3), so that upon rendering the blade resonant, the motion of the blade tends to slice into the book at an angle rather than to impinge perpendicularly against the book.

Referring now to FIG. 3, an alternate embodiment of an ultrasonic book trimmer is indicated in its entirety at 351. This trimmer includes a combination knife/horn 353 comprising a suitable horn 355 symmetrically mounting a knife 357 having a sharp cutting edge 359. Knife 357 is preferably a carbide knife where the cutting edge 359 is somewhat longer than the longest book side to be trimmed. The horn/knife is rendered resonant by a suitable booster 361 energized by an ultrasonic transducer 363, as previously described. Ultrasonic transducer 363 is powered by a suitable power supply, as well known in the art. For example, this power supply may be the above-described commercially available ultrasonic welder from Branson Ultrasonics. The ultrasonic transducer 363, booster 361 and the horn/knife 353 are biased toward a book clamped in clamp 135 and the cutting edge 359 is maintained in contact with the book as the book is trimmed by an air cylinder 365.

It will be appreciated that the horn/knife 353, the booster 361, the ultrasonic transducer 363, and the air cylinder 365 are mounted on a support plate 366 (See FIG. 1, but only a small portion of which is diagrammatically shown in FIG. 3) slidably mounted on a pair of rails 367 (as shown in FIG. 1, but only one of which is shown in FIG. 3) carried by plate 133, where the rails are disposed at an angle (e.g., a 45° angle) relative to anvil 139 and the book held against the anvil by clamp 135. Further, the support plate 366 is movable on the angled rails 367 toward and away from the book held in clamp 135 by a suitable drive (not shown), such that as the horn/knife 353 is rendered resonant and as the cutting edge 359 is biased in engagement with the book by air cylinder 365, the cutting edge 359 cuts through the book with an angled slicing action. As indicated at 369, booster 361 is supported on the support plate 366 by a clamping ring, as diagrammatically indicated by reference character 371, at its node point so as to support the booster, the transducer and the horn/knife relative to the support plate. This clamp ring has elastomeric isolation pads 372 between the clamp ring and the booster that engage the booster at its node point. By supporting these components relative to the support plate by the clamp ring 371 at the node of booster by means of isolation pads 372, ultrasonic (or sonic) energy is substantially isolated from clamping ring 371 so that substantially all of the ultrasonic energy generated by the transducer 363 is transmitted to the horn/knife assembly 353.

In view of the above, it will be seen that the several objects and features of this disclosure are achieved and other advantageous results attained.

As various changes could be made in the above constructions and methods without departing from the scope of this disclosure, it is intended that all matter contained in the above description or shown in the accompanying drawings shall be interpreted as illustrative and not in a limiting sense.

1. Apparatus for trimming a perfect bound book, the latter comprising a book block having a plurality of pages and a cover, said book block having a spine along one side thereof, said cover having a center portion adhesively bound to said spine, a front face overlying a front face of said book block and a back face overlying a back face of said book block, said trimming system comprising:
a. platen for supporting at least a portion of said book as it is trimmed;
b. a clamp for holding said book against said platen as said book is trimmed;
c. a blade having a cutting edge of a length equal to or greater than the side of said book to be trimmed, said blade being movable toward and away from said book as the latter is supported on said platen between a retracted position clear of said book and an operable position in which said cutting edge is in operative engagement with said book; and
d. a vibratory member carrying said blade, said vibratory member being selectively rendered resonant so that with said cutting edge of said blade being in it operable position in operable engagement with said book and upon said ultrasonic member being rendered resonant said cutting edge trims said book along said side of said book.

2. Apparatus as set forth in claim 1 wherein said vibratory member is an ultrasonic member, and wherein said apparatus further comprises an ultrasonic transducer operatively connected to said ultrasonic member and a power supply for said ultrasonic transducer.

3. Apparatus as set forth in claim 2 wherein said ultrasonic member is an ultrasonic horn.

4. Apparatus as set forth in claim 3 wherein said cutting blade is a carbide blade carried by said horn.

5. Apparatus as set forth in claim 3 wherein upon said horn being rendered resonant and upon said cutting edge of said blade being in operative engagement with said book, said cutting edge repeatedly moves between a retracted position in which said cutting edge does not apply a substantial cutting force to said book and a cutting position in which said cutting edge acts to at least in part shear said book such that upon said cutting edge repeatedly moving between its retracted and cutting positions substantially at the frequency at which said ultrasonic horn is rendered resonant so that said cutting edge cuts through said book along the length of the side of the book to be trimmed.

6. Apparatus as set forth in claim 5 wherein said book is generally rectangular having two major sides and two minor sides with said spine being one of said major sides and with said cutting edge being of a length equal to or greater than the length of said major sides.

7. Apparatus as set forth in claim 6 having an index clamp gripping said book proximate the spine of said book, said index clamp rotating said book relative to said cutting edge and moving said book toward or away from said cutting edge so as to present the major side of said book opposite said spine and said minor sides relative to said cutting edge so that said major side and said minor sides may be trimmed along predetermined trim lines.

8. Apparatus as set forth in claim 7 wherein after a first side of said book has been trimmed, said clamp is released and said index clamp indexes said book so as to position the next side of said book to be trimmed relative to said cutting edge so that upon re-clamping said book against said plate, upon moving said cutting edge to its operative position, and upon rendering said ultrasonic member resonant so as to trim the next side of the book.

9. Apparatus as set forth in claim 5 wherein said horn and said blade are moved between their said retracted and cutting positions along a line at an angle with respect to the book to be trimmed.

10. Apparatus as set forth in claim 9 wherein said angle is about 45°.

11. Apparatus as set forth in claim 3 wherein a booster is operatively interposed between said transducer and said horn, wherein said blade, said horn, said booster, and said transducer are carried on a support plate, and wherein said booster is supported relative to said support plate by means of a booster support clamp engaging said booster substantially at its node point.

12. Apparatus as set forth in claim 11 wherein one or more elastomeric isolation pads are interposed between said booster support clamp and said booster so as to substantially isolate said booster from said booster support clamp.

13. Apparatus as set forth in claim 1 wherein with said blade is in operable engagement with said book said blade is biased into contact with said book while said ultrasonic member is rendered resonant.

14. A method of trimming a perfect bound book utilizing a vibratory cutting blade, said book comprising a book block having a plurality of pages and a cover, said cover having a front face overlying a front face of said book block, a back face overlying a back face of said book block, and a center portion adhesively secured to one edge of said book block, said one edge constituting a spine, said method comprising the steps of:
a. clamping said book in position to be trimmed with a margin along one side of the book exposed to be trimmed;
b. moving a sharp trim blade into operable engage with said margin to be trimmed, said trim blade having a sharp cutting edge;
c. rendering resonant said trim blade while biasing said cutting edge in operable engagement with said margin; and
d. continuing to render resonant said trim blade and continuing biasing said blade in operable engagement with said margin as said cutting edge cuts through said book so as to trim said book along said margin.

15. The method of claim 14 further comprising the steps of:
e. after said margin has been trimmed, releasing said clamp;
f. rotating said book relative to said trim blade so as to position another margin of said book relative to said blade for being trimmed;
g. moving said trim blade into operable engage with said margin to be trimmed;
h. rendering resonant said trim blade while biasing said cutting edge in operable engagement with the last-said margin; and
i. continuing to render resonant said trim blade and continuing biasing said blade in operable engagement with said margin as said cutting edge cuts through said book so as to trim said book along said margin.

16. The method of claim 14 further wherein as said sharp trim blade is moved into operable engagement with said margin of said book, said blade is moved at an angle with respect to said book.

17. The method of claim 14 further comprising providing a horn carrying said trim blade, an ultrasonic transducer, and a booster operatively coupled to said transducer and to said horn for rendering said blade resonant.

18. The method of claim 17 wherein said booster is supported by an isolation clamp engaging said booster at its node.
